(19) United States
(12) Patent Application Publication
(10) Pub. No.: US 2026/0192623 A1
(43) Pub. Date: Jul. 9, 2026

(54) LEAF SPRING AXLE SUSPENSION CONVERSION ASSEMBLY

(71) Applicant: AKTV8 LLC, Wixom, MI (US)

(72) Inventor: Josh Coombs, Wixom, MI (US)

(21) Appl. No.: 19/442,369

(22) Filed: Jan. 7, 2026

Related U.S. Application Data
(60) Provisional application No. 63/742,664, filed on Jan. 7, 2025.

(51) Int. Cl. B60G 11/36; B60G 9/02; B60G 11/46; B60G 13/00; B60G 17/04

(52) U.S. Cl. CPC B60G 11/36; B60G 9/02; B60G 11/46; B60G 13/005; B60G 17/0408; B60G 2200/34; B60G 2202/112; B60G 2202/12; B60G 2202/152; B60G 2204/121; B60G 2204/129; B60G 2204/4504; B60G 2400/252; B60G 2401/172; B60G 2500/30

(57) ABSTRACT

A suspension conversion assembly includes: a brace, a spring beam, a spring member, and a lateral support arm. The brace is configured to attach to a forward leaf spring mount and a rear leaf spring mount, each on a frame of a vehicle. The spring beam is pivotably attached to the brace at a pivot, wherein the spring beam is configured to attach to an axle at an end thereof opposite from the pivot. The spring member extends between the spring beam and the axle. The lateral support arm is fixed to the spring beam and is configured to engage with a lateral support receiver of the brace for limiting movement of the axle in a lateral direction.

### CROSS REFERENCE TO RELATED APPLICATIONS

This U.S. utility patent application claims the benefit of U.S. Provisional Patent Application No. 63/742,664 filed January 7, 2025, the contents of which is incorporated herein by reference in its entirety.

### TECHNICAL FIELD

The present disclosure is generally related to suspension conversion assemblies for adjusting spring-based vehicle suspension systems, and in particular, to assemblies configured to retrofit chassis-mounted leaf spring suspensions

### BACKGROUND

Leaf spring suspensions are commonly found on trucks and large vehicles because of their low cost, packaging simplicity, and durability under heavy loads. However, these systems exhibit poor ride quality due to interleaf friction, high unsprung mass, and limited tuning flexibility, and they tend to “squat,” or reduce chassis height significantly when subjected to payloads or towing loads, adversely affecting driveline angles, headlamp aim, and handling stability. While conversion kits exist to replace leaf springs with air, hydraulic, or coil spring systems and thereby improve ride comfort and height control, many conventional solutions are complex, rely on bespoke brackets and crossmembers, and often require drilling, welding, or other permanent modifications to the vehicle frame to establish new mounting points, increasing installation time, cost, and limiting the ability to revert to the stock configuration.

### SUMMARY

According to an aspect of the present disclosure, a suspension conversion assembly includes: a brace, a spring beam, a spring member, and a lateral support arm. The brace is configured to attach to a forward leaf spring mount and a rear leaf spring mount on a frame of a vehicle. The spring beam is pivotably attached to the brace at a pivot. The spring beam is configured to attach to an axle at an end thereof opposite from the pivot. The spring member extends between the spring beam and the axle. The lateral support arm is fixed to the spring beam and is configured to engage with a lateral support receiver of the brace for limiting movement of the axle in a lateral direction.

According to another aspect of the present disclosure, a suspension conversion assembly includes a brace, a spring beam, a spring member, and an axle adapter. The brace is configured to attach to a forward leaf spring mount and a rear leaf spring mount on a frame of a vehicle. The spring beam is pivotably attached to the brace at a pivot. The spring beam is configured to attach to an axle at a position thereof spaced apart from the pivot. The spring member extends between the spring beam and the axle. The axle adapter that attaches the axle to the spring beam and the spring member.

These and other aspects of the present disclosure are disclosed in the following detailed description of the embodiments, the appended claims, and the accompanying figures.

### BRIEF DESCRIPTION OF THE DRAWINGS

FIG. 1 depicts a perspective view of a conventional leaf spring suspension.

FIG. 2 depicts a perspective view of a suspension conversion assembly for adjusting a spring suspension system attached to a vehicle chassis, according to an embodiment.

FIG. 3 depicts a side view of the suspension conversion assembly for adjusting a spring suspension system attached to a vehicle chassis, according to an embodiment.

FIGS. 4A and 4B depict a side view of the suspension conversion assembly while illustrating suspension articulation, according to an embodiment.

FIGS. 5A - 5C depict a side view of a suspension conversion assembly at three different positions – compressed, ride, and extended, respectively, according to an embodiment.

FIGS. 6A - 6C depict a suspension conversion assembly with a limit strap, according to an embodiment.

FIGS. 7A and 7B depict perspective views of a suspension conversion assembly according to an embodiment.

FIG. 8 depicts a side view of a suspension conversion assembly according to another embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

The various illustrative logical blocks, components, units, and modules described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Various embodiments may also be implemented primarily in hardware using, for example, components such as application specific integrated circuits (“ASICs”), or field programmable gate arrays (“FPGAs”). Implementation of a hardware state machine capable of performing the functions described will also be apparent to those skilled in the relevant art. Various embodiments may also be implemented using a combination of both hardware and software.

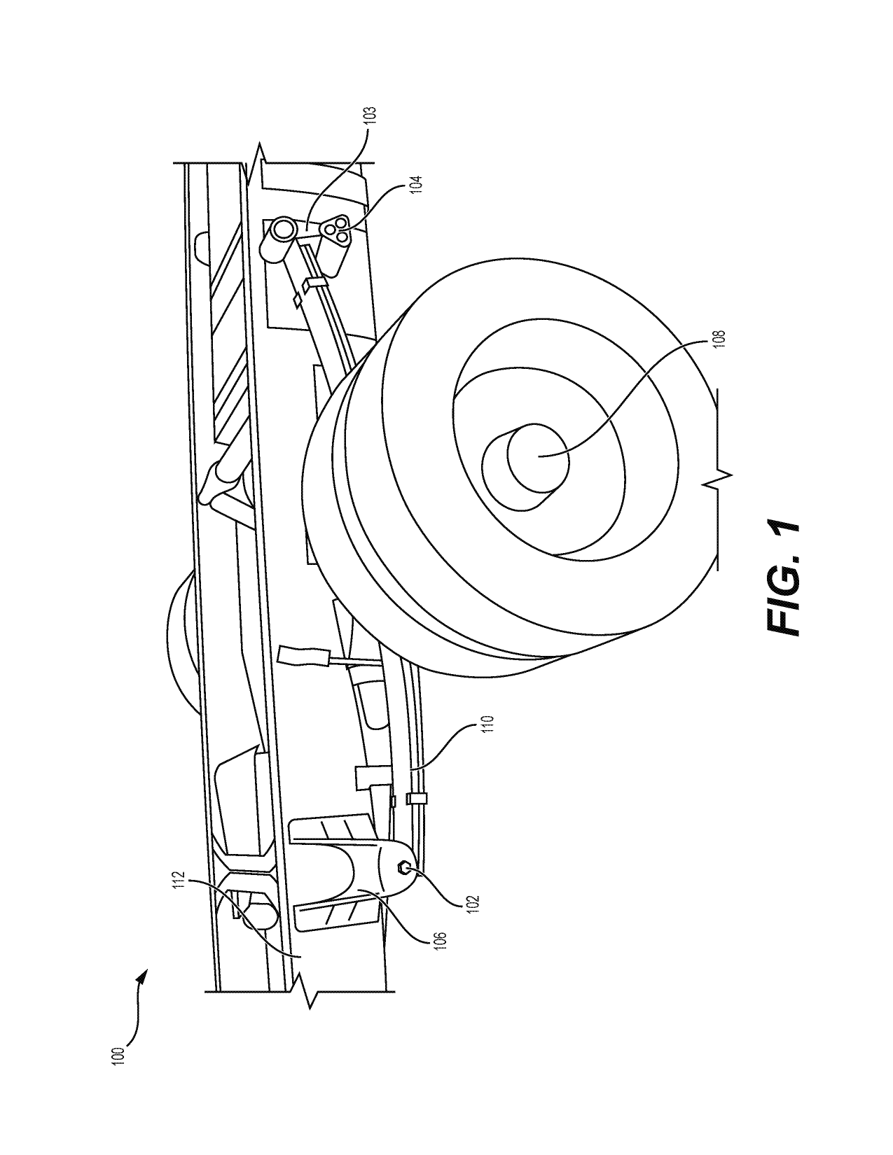

FIG. 1 illustrates an assembly 100 for a conventional leaf spring suspension system, which is commonly employed in vehicles to provide structural support, load-bearing capacity, and shock absorption. As shown, the assembly 100 is mounted to a frame rail 112 of a vehicle chassis, which serves as a primary structural framework for the suspension components and facilitates the transfer of loads between a vehicle body and an axle 108.

A forward leaf spring mount 106 is rigidly attached to the frame rail 112. The forward leaf spring mount 106 holds a front pivot bolt 102, which secures the forward end of the leaf spring 110. This configuration allows the leaf spring 110 to rotate about the front pivot bolt 102 during suspension articulation, enabling controlled vertical movement of the axle 108 relative to the frame rail 112.

A lower rear pivot bolt 104 is provided. The lower rear pivot bolt 104 fastens the aft portion of the leaf spring 110 to the frame rail 112, offering additional support and ensuring proper alignment of the suspension components. A shackle 103 connects a rear end of the leaf spring 110 to the lower rear pivot bolt, holding the rear end of the leaf spring 110 while being pivotable to allow the leaf spring 110 to vary in length as the leaf spring 110 absorbs varying load forces. This arrangement aids in maintaining the stability and durability of the suspension system under varying load conditions.

In some embodiments, the axle 108 is operatively connected below the leaf spring 110. The axle 108 facilitates the transfer of loads between the vehicle body and wheels, ensuring effective load distribution and road shock absorption.

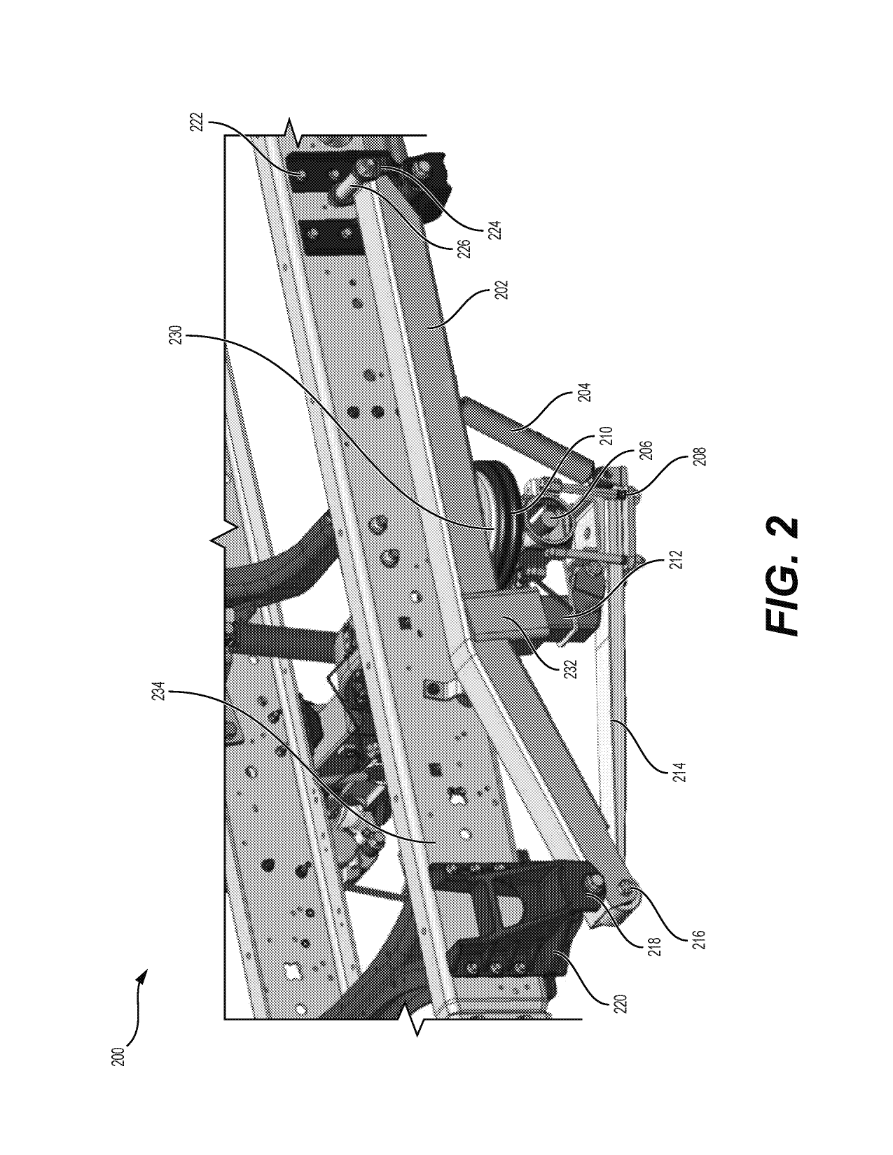

FIG. 2 illustrates a suspension conversion assembly 200 for adjusting a spring suspension system attached to a frame rail 234, according to an embodiment. As shown, the suspension conversion assembly 200 includes a brace 202, which serves as a structural component for mounting and supporting other elements of the suspension system. The brace 202 is configured to attach to both a forward leaf spring mount 220 and a rear leaf spring mount 222, thereby providing a robust foundation for the suspension conversion assembly 200. In some embodiments, the brace 202 is formed from a rigid metallic material and sized to span the distance between the forward and rear leaf spring mounts. For example, the brace 202 may include interchangeable end sections or adjustable interfaces to accommodate variations in leaf spring mount spacing across different vehicle platforms, while maintaining concentric alignment with existing pivot hardware.

In some embodiments, a spring beam 214 is rotatably attached to the brace 202 at a spring beam mounting hole 216. This rotational connection allows the spring beam 214 to articulate during suspension movement, enabling the axle 206 to move vertically relative to the frame rail. The spring beam 214 is further equipped with a front mounting tube 218, which facilitates secure attachment to the forward leaf spring mount 220 and ensures proper alignment under load. In some embodiments, the spring beam 214 is configured with a width greater than its thickness to promote vertical compliance while resisting lateral deflection. For example, the spring beam 214 may incorporate a vibration-isolating bushing or bearing at the spring beam mounting hole 216 to reduce wear and provide smooth articulation under repeated cycling, while the front mounting tube 218 is oriented perpendicular to the longitudinal axis of the brace 202 to maintain consistent geometry through the suspension travel.

In some embodiments, an axle 206 is operatively connected to the suspension system via an axle adapter 208. The axle adapter 208 serves as an interface between the axle 206, the spring beam 214, and other suspension components, ensuring proper alignment and load distribution. A spring 210 is positioned between the spring beam 214 and the axle 206, providing necessary suspension support and shock absorption. In some embodiments, the spring 210 may be implemented as an air spring, coil spring, or hydraulic spring, depending on the specific embodiment. In some embodiments, the axle adapter 208 includes provisions for securing the spring beam 214 and spring 210 in a manner that maintains axle pinion angle and ride height across compression and extension. For example, the axle adapter 208 may be configured with mounting features that enable straightforward installation and serviceability, and the spring 210 may be paired with a jounce element to mitigate impact loads at full compression.

In some embodiments, a lateral support arm 212 is fixed to the spring beam 214 and engages with a lateral support receiver 232 on the brace 202. This configuration limits lateral movement of the axle 206, enhancing stability during operation. In some embodiments, the lateral support arm 212 is formed from a single piece of metal bent to define the lateral support arm 212 as a continuous, unitary member. For example, the lateral support arm 212 may be laser-cut from a steel blank and press-formed to include a radiused sliding face that remains tangent to the brace-side guide surface through full travel, thereby reducing weld joints, improving durability, and simplifying manufacturing while preserving lateral stiffness.

In some embodiments, the suspension conversion assembly 200 is configured without a lateral support arm 212, and lateral constraint is maintained by the geometry of the bushing or bearing at the spring beam mounting hole 216, compliant bushings at the front mounting tube 218, and widened contact surfaces on the axle adapter 208. For example, a high-durometer bushing at the front mounting tube 218 and a broadened pedestal interface at the axle adapter 208 may provide sufficient lateral guidance for on-road applications, allowing the suspension conversion assembly 200 to attach to stock mounts while omitting the lateral support arm 212 and lateral support receiver.

In some embodiments, a shock absorber 204 is coupled between the brace 202 and the axle adapter 208 to dampen relative motion between the axle 206 and the vehicle chassis, thereby improving ride comfort and reducing vibrations. The brace 202 further includes parallel flanges 224 and a rear mounting tube 226 to provide additional structural support and facilitate secure attachment of the rear leaf spring mount 222. As a result, a spring mounting interface 230 serves as a connection point for the spring 210, ensuring proper alignment and load transfer. In some embodiments, the lateral support arm 212 is dimensioned to remain within the lateral support receiver 232 over the full suspension travel to maintain guidance throughout compression and extension. For example, the lateral support receiver 232 may include a low-friction interface to reduce wear and ensure consistent lateral constraint, and the shock absorber 204 may be positioned to minimize changes in effective damping leverage across the operating range.

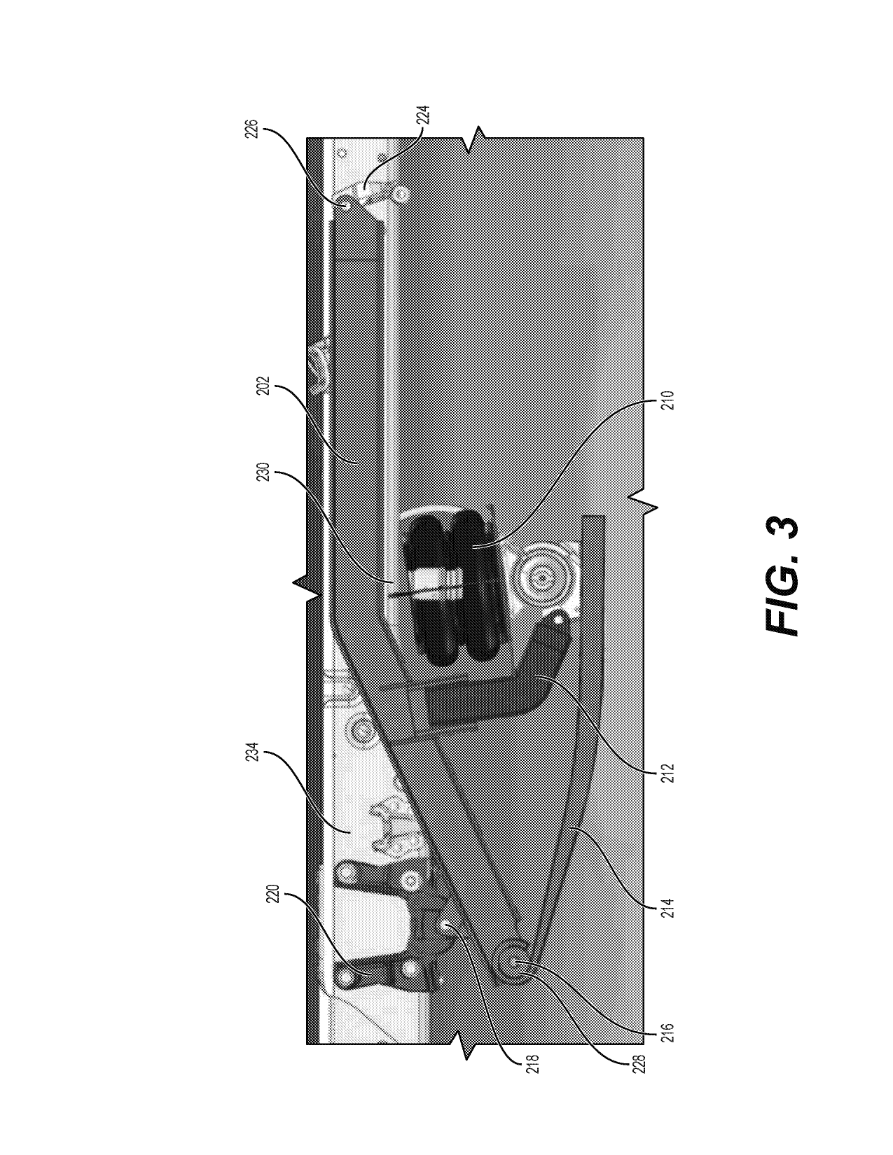

FIG. 3 illustrates a side view of the suspension conversion assembly 200 for a spring suspension system attached the frame rail 234 of the vehicle chassis. As shown, the assembly includes a brace 202, which serves as the primary structural component for mounting and supporting other elements of the suspension system. The brace 202 is configured to attach to both a forward leaf spring mount 220 and a rear mounting tube 226, providing a robust foundation for the suspension conversion assembly. In some embodiments, the brace 202 includes mounting features oriented to align with stock pivot locations and is arranged to facilitate bolt-in installation. For example, the forward and rear interfaces may be positioned and oriented horizontally relative to the ground plane to maintain compatibility with factory hardware and minimize installation complexity.

In some embodiments, a spring beam 214 is rotatably attached to the brace 202 at a spring beam mounting hole 216. This connection allows the spring beam 214 to articulate during suspension movement, thereby enabling the axle to move vertically relative to the frame rail 234 of the vehicle chassis. A bushing 228 is also positioned at the spring beam mounting hole 216 to facilitate smooth rotational movement of the spring beam 214, reducing wear and promoting durability over extended operation. In some embodiments, the pivot location of the spring beam 214 is selected to balance axle articulation, anti-squat, and brake dive characteristics. For example, the spring beam mounting hole 216 may be positioned slightly forward and below the forward leaf spring mount 220 to reduce angular change during travel and improve vehicle stability under acceleration and braking.

In some embodiments, the spring beam 214 is equipped with a front mounting tube 218, which facilitates secure attachment to the forward leaf spring mount 220. This configuration ensures proper alignment and load distribution under varying operating conditions. Furthermore, a lateral support arm 212 is fixed to the spring beam 214 and engages with the brace 202 to limit lateral movement of the axle, enhancing the stability of the suspension system. In some embodiments, the lateral support arm 212 is dimensioned and oriented to maintain clearance with adjacent components through full travel while providing consistent lateral guidance. For example, the lateral support arm 212 may incorporate wear-resistant contact surfaces at its interface with the brace 202 to promote durability during extended use.

In some embodiments, a spring 210 is positioned between the spring beam 214 and the brace 202. The spring 210 provides necessary suspension support and shock absorption, ensuring effective load distribution and ride comfort. The spring mounting interface 230 serves as a connection point for the spring 210, ensuring proper alignment and reliable transfer of loads between the spring beam 214 and the brace 202. In some embodiments, the spring mounting interface 230 is located above the axle to optimize packaging, ground clearance, and load paths. For example, the spring 210 may be sized to accommodate anticipated vehicle load ranges, and the mounting interface geometry may be selected to maintain the desired ride height and allow sufficient travel in compressed, nominal, and extended positions

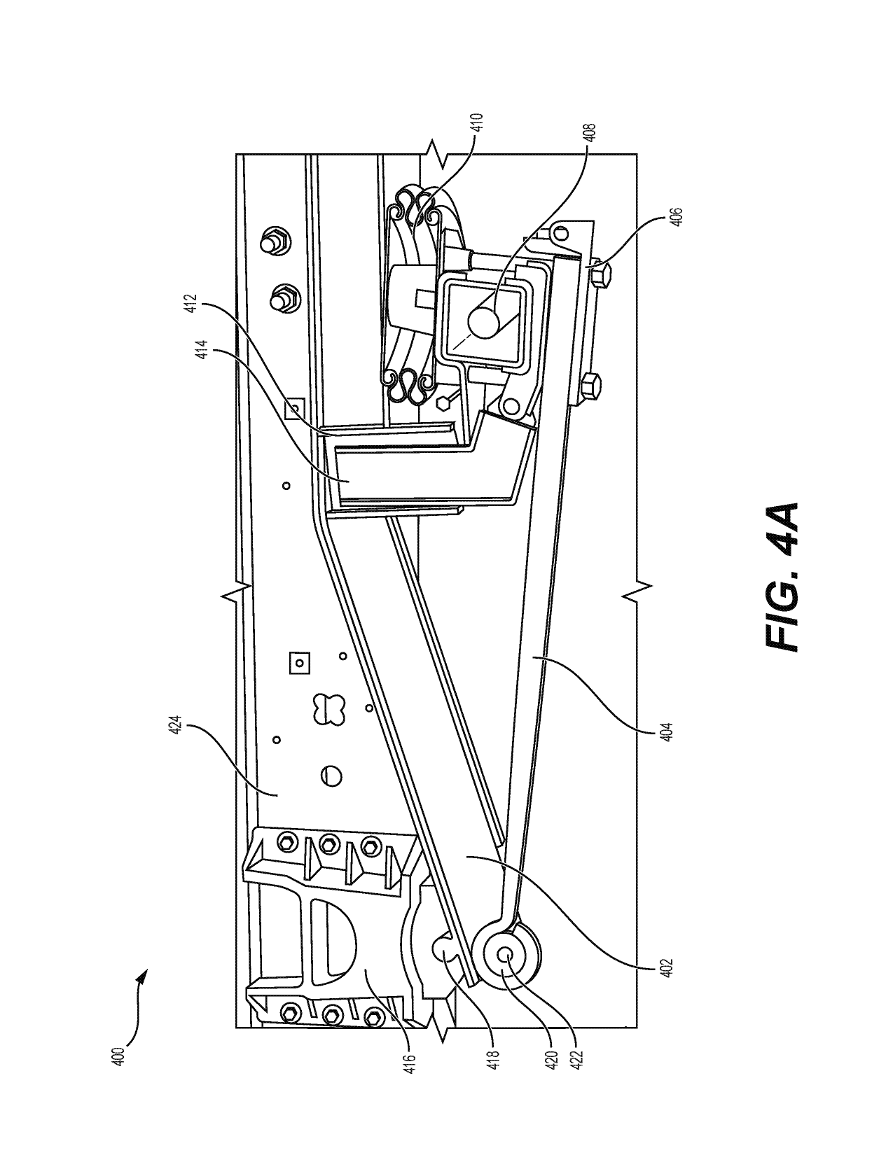

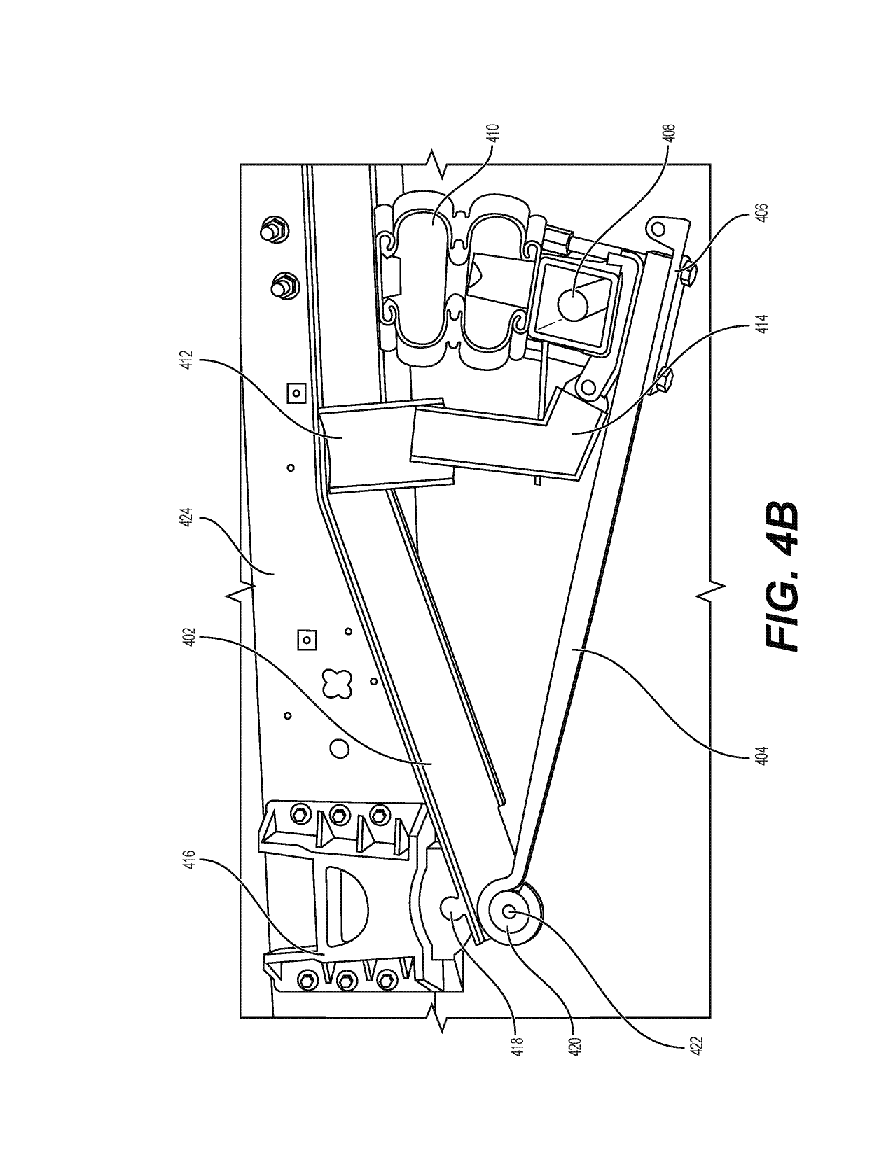

FIG. 4A illustrates a suspension conversion assembly 400 mounted to a vehicle chassis 424, according to an embodiment. As shown, a brace 402 is secured to the chassis 424 and provides a structural foundation for supporting a spring beam 404, an axle adapter 406, and an axle 408. A front mounting tube 418 at the forward end of the brace 402 interfaces with a forward leaf spring mount 416, while a spring beam mounting hole 422 houses a bearing 420 to permit controlled rotation of the spring beam 404. A lateral support receiver 412 is affixed to the brace 402 to provide additional stiffness and to serve as a lateral receiver or guide surface for a lateral support arm 414 extending from the spring beam 404. An air spring 410 is positioned proximate the axle adapter 406 to react vertical loads between the axle 408 and the brace 402. In some embodiments, the brace 402 includes multiple fastener locations and offset brackets that align with factory frame holes to enable bolt-in installation while distributing loads through the chassis 424 side rail. For example, the brace 402 may incorporate weldments or rivet-nut interfaces at the lateral support receiver 412 to increase torsional rigidity and reduce localized stress near the spring beam 404 pivot.

In some embodiments, the spring beam 404 is rotatably supported at the bearing 420 within the spring beam mounting hole 422, allowing the axle 408 to move in an arc relative to the chassis 424 while maintaining consistent pinion orientation through travel. For example, the bearing 420 may comprise a self-lubricating polymer bushing or a sealed cartridge bearing selected to accommodate combined radial and axial loads, with a shoulder bolt serving as the pivot pin to constrain endplay. In some embodiments, the front mounting tube 418 couples to the forward leaf spring mount 416 using the factory pivot bolt to preserve geometry and simplify installation. For example, a stepped sleeve within the front mounting tube 418 may center the suspension conversion assembly 400 relative to the forward leaf spring mount 416 and provide crush resistance when the bolt is torqued to specification.

In some embodiments, the axle adapter 406 rigidly couples the axle 408 to the distal end of the spring beam 404 and provides mounting features for the air spring 410 and the lateral support arm 414. For example, the axle adapter 406 may include contoured plates that capture the axle 408 using U-bolts and a welded pedestal that locates the lower bell plate of the air spring 410 directly above the axle 408 centerline to optimize load paths. In some embodiments, the lateral support arm 414 engages the lateral support receiver 412 on the brace 402 to constrain lateral motion of the axle assembly and maintain wheel alignment under cornering loads. For example, the interface between the lateral support arm 414 and lateral support receiver 412 may include a replaceable low-friction liner to reduce wear and noise while preserving guidance across the full range of motion.

In some embodiments, the geometry of the spring beam 404, the pivot at bearing 420, and the mounting of the air spring 410 are selected to yield a favorable motion ratio that maintains comfort while controlling bottoming at full compression. For example, the spring beam 404 may be tapered in section to balance vertical compliance and bending strength, with reinforcement near the pivot to limit deflection under braking loads.

FIG. 4B illustrates the suspension conversion assembly in a different articulation state relative to FIG. 4A and highlights the kinematic relationship between the lateral support arm 414 and the lateral support receiver 412 on the brace 402. In some embodiments, the lateral support arm 414 is configured to follow a constrained path that combines rotation about the spring beam pivot at the bearing 420 with guided translation along the lateral support receiver 412, thereby maintaining lateral constraint while accommodating vertical motion of the axle 408. For example, when the axle 408 moves through its travel from the condition depicted in FIG. 4A toward the condition shown in FIG. 4B, the distal end of the lateral support arm 414 slides down along the lateral support receiver 412 as the spring beam 404 rotates about the spring beam mounting hole 422, keeping the arm’s contact patch centered within the guide window to prevent binding.

In some embodiments, FIG. 4A represents a higher ride-height or partially compressed state in which the lateral support arm 414 engages an upper region of the lateral support receiver 412, while FIG. 4B represents a lower ride-height or further compressed state in which the arm 414 has translated downward along the lateral support receiver 412. For example, the geometry of the lateral support arm 414 may be angled such that its sliding face remains tangent to the guide surface of the lateral support receiver 412 across the full arc of the spring beam 404, producing a smooth transition of contact from a first elevation in FIG. 4A to a second, lower elevation in FIG. 4B.

In some embodiments, the comparison between FIGS. 4A and 4B also reflects a change in motion ratio and damping leverage due to the evolving geometry between the spring beam 404, the air spring 410, and the axle adapter 406, while lateral guidance remains consistent because the lateral support arm 414 tracks the lateral support receiver 412 continuously. For example, as the lateral support arm 414 slides down the lateral support receiver 412 from the position in FIG. 4A to the position in FIG. 4B, the air spring 410 may compress further and the axle 408 may rotate slightly about its mounts, yet the lateral constraint is preserved by the guided interface, preventing wheel steer or scrub during articulation.

In some embodiments, tolerances and clearances at the arm-to-lateral support receiver feature interface are set to accommodate manufacturing variation and frame flex without introducing rattle or binding at any point along the sliding path observed in FIGS. 4A and 4B. For example, the lateral support arm 414 may include adjustable shims or a compliant bushing captured against the lateral support receiver 412 to maintain a target running clearance as the contact point migrates downward, ensuring repeatable articulation over time.

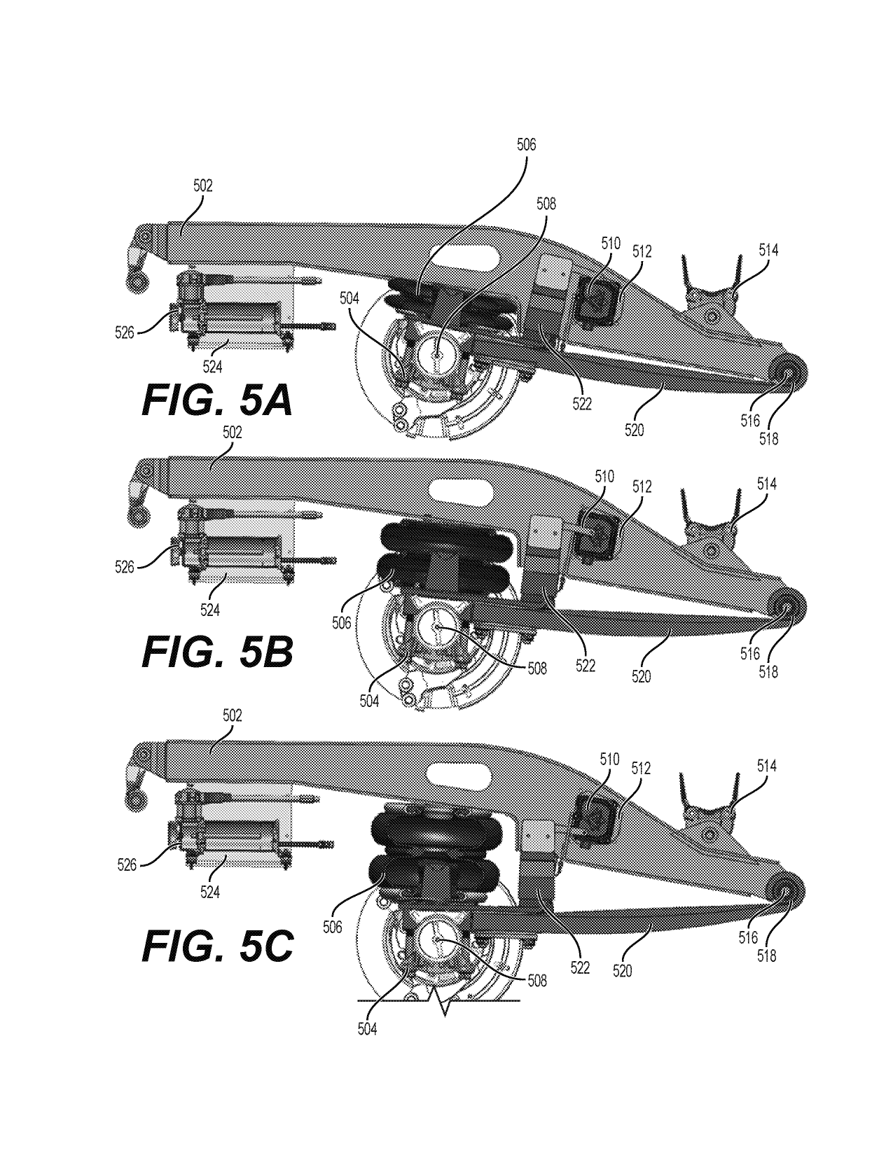

FIG. 5A illustrates the compressed position in which the air spring 506 is at or near maximum compression and the spring beam 520 has rotated upward toward the brace 502 about the spring beam mounting hole 516 and bearing 518. In some embodiments, the upper spring interface on the brace 502 and the lower interface on the axle adapter 504 are arranged to maintain a favorable motion ratio at high compression and to prevent interference with adjacent components. For example, a jounce bumper of polymer, elastomer, or rubber may be seated within or adjacent to the air spring 506 to absorb impact loads at full compression and reduce stress transmitted to the brace 502, spring beam 520, and axle adapter 504. In some embodiments, the lateral support arm 522 remains captured against the lateral support receiver integrated into the brace 502 along an upper contact region, preserving lateral stiffness while accommodating vertical displacement. For example, a low-friction liner may be affixed to the inner surface of the brace-side guide feature to limit wear and noise as the arm’s contact patch transitions upward during compression.

In some embodiments, the axle adapter 504 provides rigid coupling to the axle 508 using a clamshell or U-bolt arrangement with a pedestal locating the spring centerline, maintaining pinion orientation and preventing clamp slip under high loads. For example, wedges may be incorporated between the spring beam 520 and axle adapter 504 to fine-tune pinion angle for NVH control without altering the overall geometry of the compressed configuration. In some embodiments, a compressor 526 is mounted to the brace 502 via a compressor adapter 524 to supply pressurized air to the air spring 506 under command from a pneumatic control module (PCM) 510. For example, the compressor adapter 524 may provide standoff spacing and integrated routing channels that keep electrical leads and air lines clear of the spring beam 520 and axle adapter 504 during full compression.

FIG. 5B illustrates the ride position representative of nominal vehicle height during steady-state operation. In some embodiments, the air spring 506 is pressurized to maintain target ride height, and the pivot location of the spring beam 520 relative to the brace 502 is selected to balance anti-squat and brake dive while keeping the axle 508 motion arc compatible with driveline angles. For example, the spring beam pivot may be located slightly forward and below the forward leaf spring mount 514 to reduce angular change with vertical movement and stabilize chassis behavior. In some embodiments, the lateral support arm 522 engages a mid-elevation region of the brace-side guide feature, maintaining consistent lateral constraint with minimal friction. For example, the lateral support arm 522 may incorporate a radiused wear surface or replaceable contact element that preserves contact area and reduces point loading during repeated cycling around the ride position. In some embodiments, the axle adapter 504 supports the air spring 506 lower bell plate directly above the axle 508 centerline to optimize load paths into the brace 502 via the spring beam 520. For example, slotted holes or alignment shims on the axle adapter 504 may permit fine adjustment of axle position and pinion angle without compromising clamp load or the alignment of the spring interfaces. In some embodiments, the PCM 510, mounted to the brace 502 with a PCM adapter 512, regulates compressor 526 operation to hold the target height while monitoring system status. For example, the PCM adapter 512 may position the PCM 510 to shorten air line runs from the compressor adapter 524 to the air spring 506 and to provide protected cable management along the brace 502.

FIG. 5C illustrates the extended position in which the air spring 506 is at or near maximum extension and the spring beam 520 has rotated downward away from the brace 502, increasing axle-to-chassis separation while remaining pivoted at the spring beam mounting hole 516 and bearing 518. In some embodiments, the lateral support arm 522 slides downward along the lateral support receiver to a lower contact region while maintaining lateral stiffness and avoiding binding. For example, tolerances at the lateral support receiver may be set with shims or compliant bushings to accommodate frame flex and manufacturing variations, preventing rattle through the full stroke. In some embodiments, the PCM 510 and compressor 526, each mounted to the brace 502 via the PCM adapter 512 and compressor adapter 524 respectively, are arranged to facilitate installation and maintain ride height via closed-loop regulation after an extension event. For example, the PCM 510 may sense height changes using a position or hall-effect sensor array and command the compressor 526 to adjust air spring 506 pressure to restore the target height once the suspension returns from full extension.

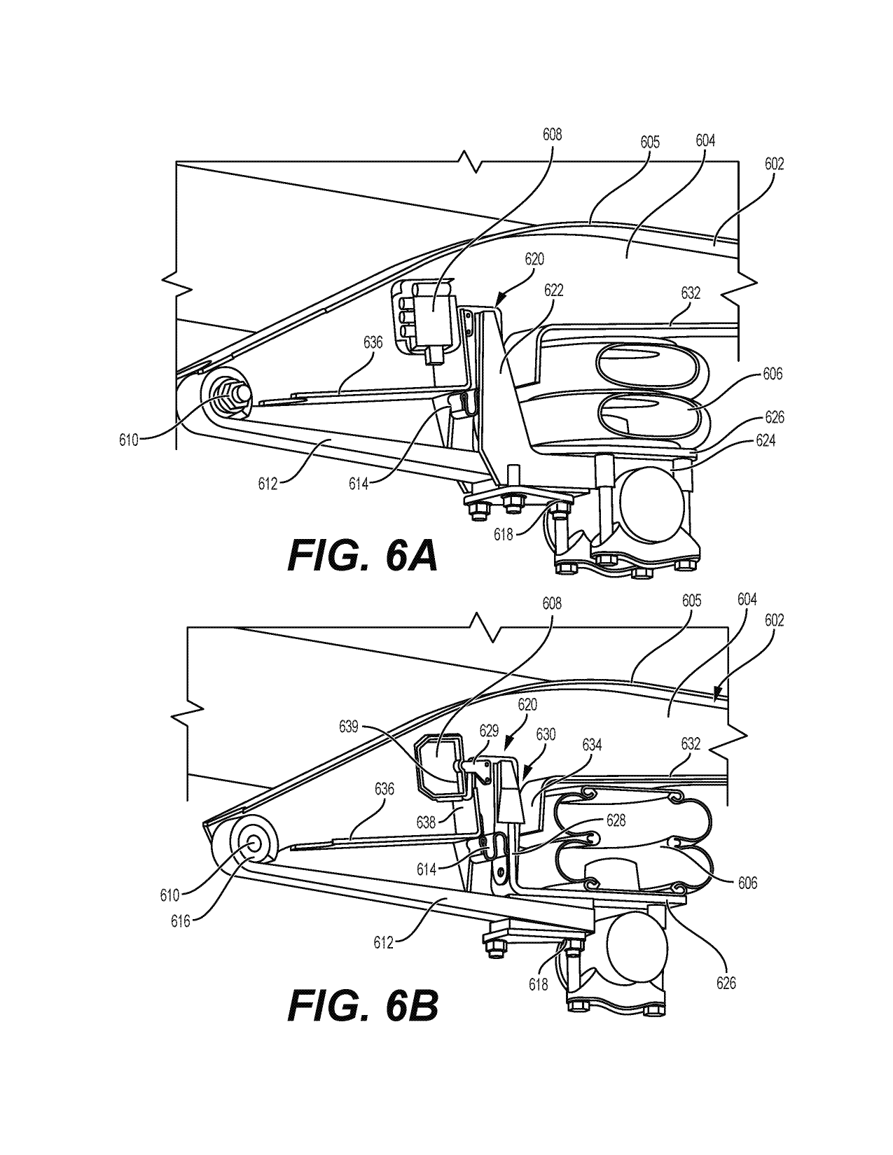

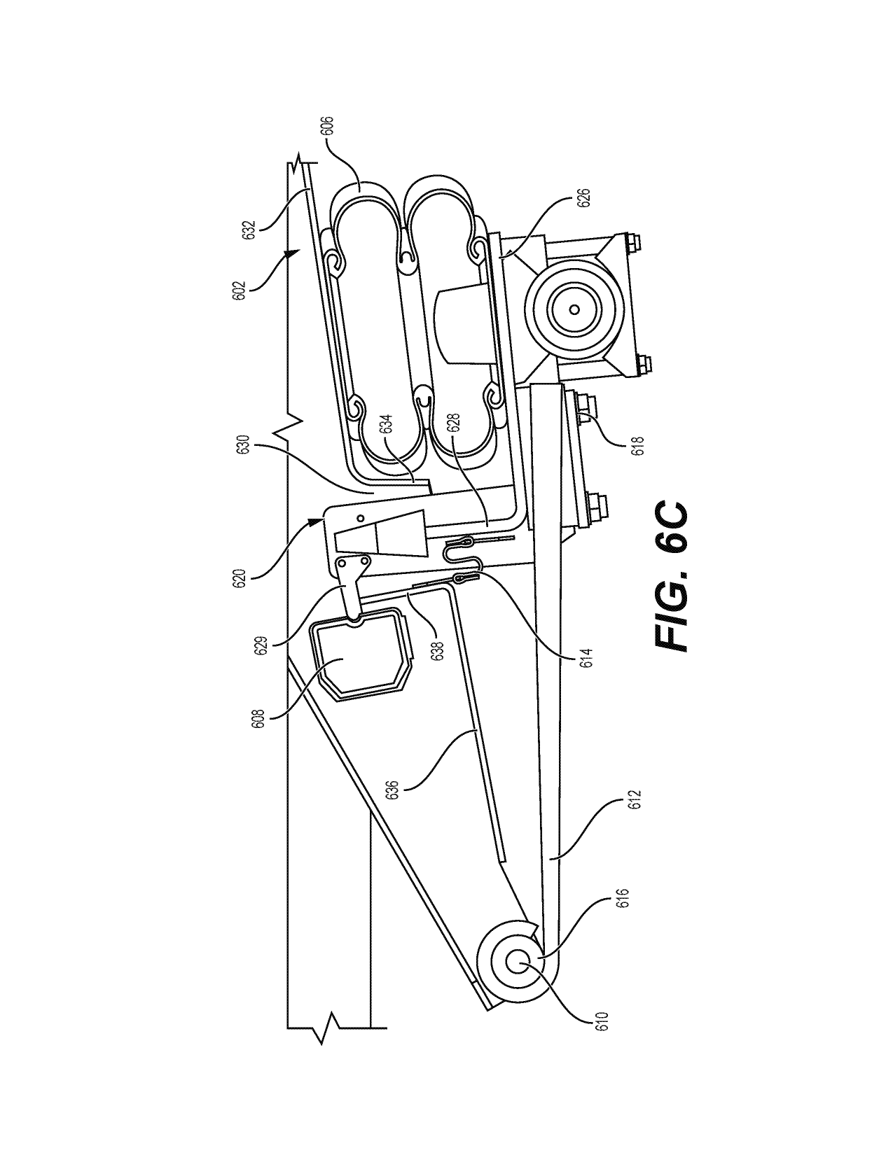

FIGS. 6A–FIG. 6C highlight the function and integration of a limit strap 614 within a suspension conversion assembly, emphasizing its role as the primary mechanism for controlling maximum extension while remaining unobtrusive during compression and mid-travel articulation. The assembly includes a brace 602, a spring beam 612 pivoted at a mounting bolt 610 with a bushing 616, an axle adapter 618 carrying the lower spring interface for an air spring 606, a lateral support arm 620 that provides lateral guidance, and a pneumatic control module (PCM) 608. The brace 602 defines a lateral support receiver 630 that receives and engages the lateral support arm 620 for limiting lateral travel of the axle.

The brace 602 has a boxed construction with a pair of vertical walls 604 and a top plate 605 extending therebetween along a top edge thereof. The brace 602 includes a rear lower wall 632 that extends horizontally along a lower edge of the vertical walls 604, generally parallel to the top plate 605. The rear lower wall 632 defines a 90-degree bend to form a rear wall 634 of the lateral support receiver 630. The rear lower wall 632 of the brace 602 may function as an upper spring mount for engaging a top surface of the air spring 606.

The brace 602 also includes a forward lower plate 636 that extends along a lower edge of the along a lower edge of the vertical walls 604, generally perpendicular thereto and opposite from the top plate 605. The forward lower plate 636 defines a 90-degree bend to form a front wall 638 of the lateral support receiver 630. The front wall 638 extends vertically and is parallel to and spaced apart from the rear wall 634. The front wall 638 defines an aperture 639. A flag 629 is connected to the lateral support arm 620 and protrudes through an aperture 639 in the front wall 638. The PCM 608 includes a displacement sensor, such as an array of hall effect sensors, for detecting a position of the flag 629, and thereby detecting a displacement of the axle relative to the brace 602.

The lateral support arm 620 has a generally L-shaped configuration with a pair of side plates 622, 624 that extend generally vertical and are spaced and parallel to one another. Each of the side plates 622, 624 includes a lower portion 624 with a horizontally-elongated rectangular shape and an upper portion 622 attached to a front end of the lower portion 624 and which extends upward, generally perpendicular thereto. The lateral support arm 620 also includes an inner bracket 626, 628 with a horizontal portion 626 that extends generally horizontally between the lower portions 624 of the side plates 622, 624. The inner bracket 626, 628 defines a 90-degree bend and includes a vertical portion 628 that extends generally vertically between the upper portions 622 of the side plates 622, 624. The vertical portion 628 and the upper portions 622 of the side plates 622, 624 each extend upwardly and into the lateral support receiver 630 of the brace 602. The horizontal portion 626 of the inner bracket 626, 628 may function as a lower spring mount for engaging a lower end of the air spring 606.

In some embodiments, the limit strap 614 is configured as a flexible, high-tension member that defines the maximum separation between the brace 602 and the axle adapter 618 without introducing harsh mechanical stops. For example, the limit strap 614 may comprise a fabric strap formed from high-strength woven fibers, a chain, or another flexible element engineered to withstand repeated tension cycles. The strap 614 is mounted at both ends via bolted interfaces to ensure load transfer and consistent travel limits. The strap 614 is attached, at one end, to the vertical portion 628 of the lateral support arm 620. The strap 614, is attached, at an opposite end, to the front wall 638 of the brace 602, on a surface thereof facing toward the rear wall 634.

FIG. 6A depicts an installation and nominal ride-height condition in which the limit strap 614 lies slack or only lightly loaded, positioned adjacent the spring beam 612 and routed to avoid interference with the air spring 606 and the lateral support arm 620. In some embodiments, the strap 614 is oriented to flex out of the way during compression, maintaining clearance to moving components while preventing chafing. For example, the upper bolted interface on the brace 602 may include a radiused eyelet or protective sleeve, and the lower bolted interface on the axle adapter 618 may be located on a dedicated mounting plate that keeps the strap path clear of fasteners, brackets, and the sliding face of the lateral support arm 620.

FIG. 6B illustrates the assembly in mid-travel articulation, where the spring beam 612 rotates about the bushing 616 and the lateral support arm 620 translates along the brace-side guide surface. In some embodiments, the limit strap 614 remains largely unengaged in tension during this phase, continuing to flex and track component motion without inducing friction or noise. For example, the strap length and anchor geometry may be selected so that tension does not develop until the suspension approaches the design extension threshold, minimizing any effect on motion ratio, damping leverage, or lateral guidance while the arm 620 maintains contact within the defined guide window.

FIG. 6C shows the assembly at the extended condition where the limit strap 614 straightens and approaches full tension, arresting further separation between the brace 602 and the axle adapter 618. In some embodiments, the strap 614 provides a progressive stop by elongating minimally under load while distributing forces through its bolted interfaces to prevent shock to the spring beam 612, bushing 616, and air spring 606. For example, the strap may incorporate layered construction with abrasion-resistant outer sheaths and high-tenacity cores, while the anchor plates on the brace 602 and axle adapter 618 include broad bearing surfaces and hardened hardware to sustain repeated peak loads without loosening.

In some embodiments, the mounting hardware and path of the limit strap 614 are engineered to avoid twisting, edge loading, or contact with sharp features, thereby improving durability and reducing maintenance. For example, the upper brace-side anchor may employ a clevis with a radiused pin to maintain strap alignment, and the lower axle-side anchor may employ a recessed pocket or standoff that keeps the strap 614 clear of the lateral support arm 620 throughout the stroke. In some embodiments, the strap 614 length is selected to prevent the shock absorber, when present, from topping out, protecting internal valving and bushings while also limiting driveline angularity at full extension. For example, the strap 614 may be calibrated to engage just before the shock reaches its maximum extended length, ensuring the strap carries the terminal loads rather than the shock rod or seals.

In some embodiments, wear management features are incorporated to preserve the strap and anchors over long service intervals. For example, protective sleeves may be placed over regions of the strap that pass near the spring beam 612 or the PCM 608, and the bolted interfaces may include locking nuts and torque-indicating washers to verify clamp integrity after impact events. In some embodiments, the strap can be field-serviced by removing the bolted interfaces and replacing the flexible member without disturbing the air spring 606, axle adapter 618, or lateral support arm 620, reducing downtime and cost.

In some embodiments, the PCM 608 coordinates with the limit strap 614 to manage system behavior near full extension. For example, the PCM 608 may interpret height signals from a position sensor or hall-effect array and detect strap engagement by recognizing the characteristic end-of-travel height profile, thereby inhibiting compressor overrun and preserving sufficient air spring pressure to promptly restore ride height when loads return.

In some embodiments, the PCM 608 is operatively coupled to a pressure sensor fluidly connected to the air spring 606 and configured to measure spring pressure for closed-loop regulation. For example, the pressure sensor may be integrated into the PCM 608 manifold or mounted on the air line to the bellows, and the PCM 608 may command inflation or deflation in response to pressure feedback combined with height estimates from the position sensor or hall-effect array to maintain the target ride height under varying loads.

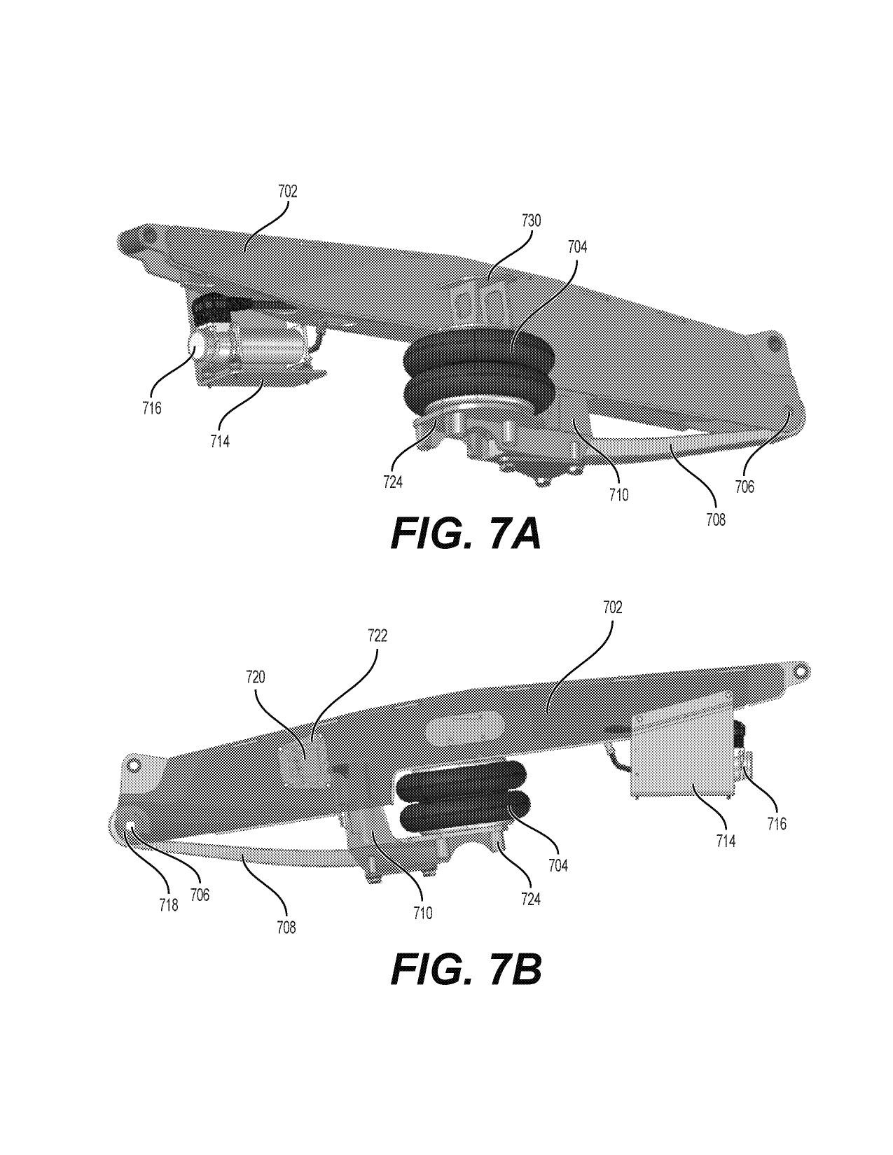

FIG. 7A illustrates a perspective view of a suspension conversion assembly with a brace 702 configured to support and position auxiliary components differently than the braces shown in earlier figures. As depicted, the brace 702 carries a compressor 716 on a compressor adapter 714 mounted to the underside-forward region of the brace 702, while the spring 704 is arranged above an axle adapter 724 to react vertical loads into the brace through a spring beam 708. A spring beam mounting hole 706 at the distal end of the brace 702 houses a bearing 718 that rotatably supports the spring beam 708, establishing the primary pivot for axle articulation. A lateral support arm 710 extends from the axle-side region to provide lateral guidance relative to the brace 702. In some embodiments, the brace 702 is shaped and reinforced to present discrete attachment surfaces for pneumatic and electronic modules, routing paths for wiring and air lines, and clearance features for the spring beam 708 while maintaining bolt-in interfaces to stock leaf spring mounts. For example, the brace 702 may employ localized weldments or bracketry integrated with the compressor adapter 714 to isolate vibration, protect the compressor 716, and simplify service access without altering the pivot geometry at the spring beam mounting hole 706.

In some embodiments, and as shown on FIG. 7A, a support pad 730 is located above the spring 704. The support pad 730 is configured to engage an original-equipment (OE) jounce bumper that is attached to the frame rail 234, during high vertical loads. The support pad 730, may therefore further distribute loads to the frame through the jounce bumper area that is designed to take such vertical loads, reducing the maximum load on the brace 702.

In some embodiments, the arrangement shown in FIG. 7A locates the compressor 716 is located opposite the spring 704 to balance mass distribution along the brace 702 and to minimize interference with the spring beam 708 across compressed, ride, and extended positions. For example, the compressor adapter 714 may include strain-relief features and cable channels that direct electrical leads away from the spring beam 708 and the axle adapter 724, while the bearing 718 at the spring beam mounting hole 706 is selected to accommodate combined radial and axial loads induced by braking and cornering. In some embodiments, the lateral support arm 710 is configured to remain captured within a defined guide window on the brace-side interface throughout travel, whether realized as a lateral support receiver feature or a low-friction contact surface integrated to the brace 702. For example, the arm-to-brace interface may incorporate a replaceable liner to reduce wear and noise while preserving lateral constraint.

FIG. 7B illustrates another perspective view of the suspension conversion assembly in which the brace 702 is configured to mount a pneumatic control module (PCM) 720 to an intermediate side face using a PCM adapter 722, while the compressor 716 is positioned at the opposite end of the brace on the compressor adapter 714. As shown, the spring 704 remains over the axle adapter 724, and the spring beam mounting hole 706 with bearing 718 supports rotation of the spring beam 708. In some embodiments, the brace 702 in FIG. 7B differs from the configuration of FIG. 7A by including a recessed or contoured panel region and fastener bosses that accept the PCM adapter 722, thereby creating a protected pocket for the PCM 720, improving cable management, and shortening pneumatic line runs to the spring 704. For example, the PCM adapter 722 may provide standoff spacing and integrated routing channels that separate high-current compressor wiring from sensor leads and height-feedback harnesses.

In some embodiments, the PCM 720 is operatively coupled to the compressor 716 and to sensors for closed-loop regulation and fault protection while leveraging the brace-mounted locations shown. For example, the PCM 720 may interface with temperature, electrical current, and voltage sensors to inhibit compressor operation under overheat or brownout conditions, an accelerometer to adjust pressure during transient maneuvers, and a position sensor or hall-effect array to sense the location of a suspension-mounted magnet for precise height control. In some embodiments, the lateral support arm 710 can be welded to the top of the axle adapter 724 to simplify assembly and create a rigid coupling that preserves alignment through travel. For example, the welded joint may locate the lateral support arm 710 such that its sliding or contact face remains tangent to the brace-side guide surface, reducing wear and maintaining consistent lateral stiffness while the spring beam 708 articulates about the bearing 718. In some embodiments, the brace 702 includes alternative mounting tubes or parallel flanges concentric to stock leaf spring pivot hardware to enable bolt-in installation across different vehicle platforms while supporting the distinct compressor 716 and PCM 720 placements shown between FIGS. 7A and 7B. For example, interchangeable end sections or adjustable interfaces on the brace 702 may be used to accommodate variations in leaf spring mount spacing and to maintain clearance to the PCM 720 and compressor 716 without changing the fundamental suspension geometry.

In some embodiments, the PCM 720 is configured to monitor compressor run-time and inhibit operation when a maximum run-time threshold is exceeded to prevent overheating and premature wear. For example, the PCM 720 may track cumulative or continuous compressor 716 operation time and suspend inflation until temperature and electrical supply conditions return to acceptable ranges.

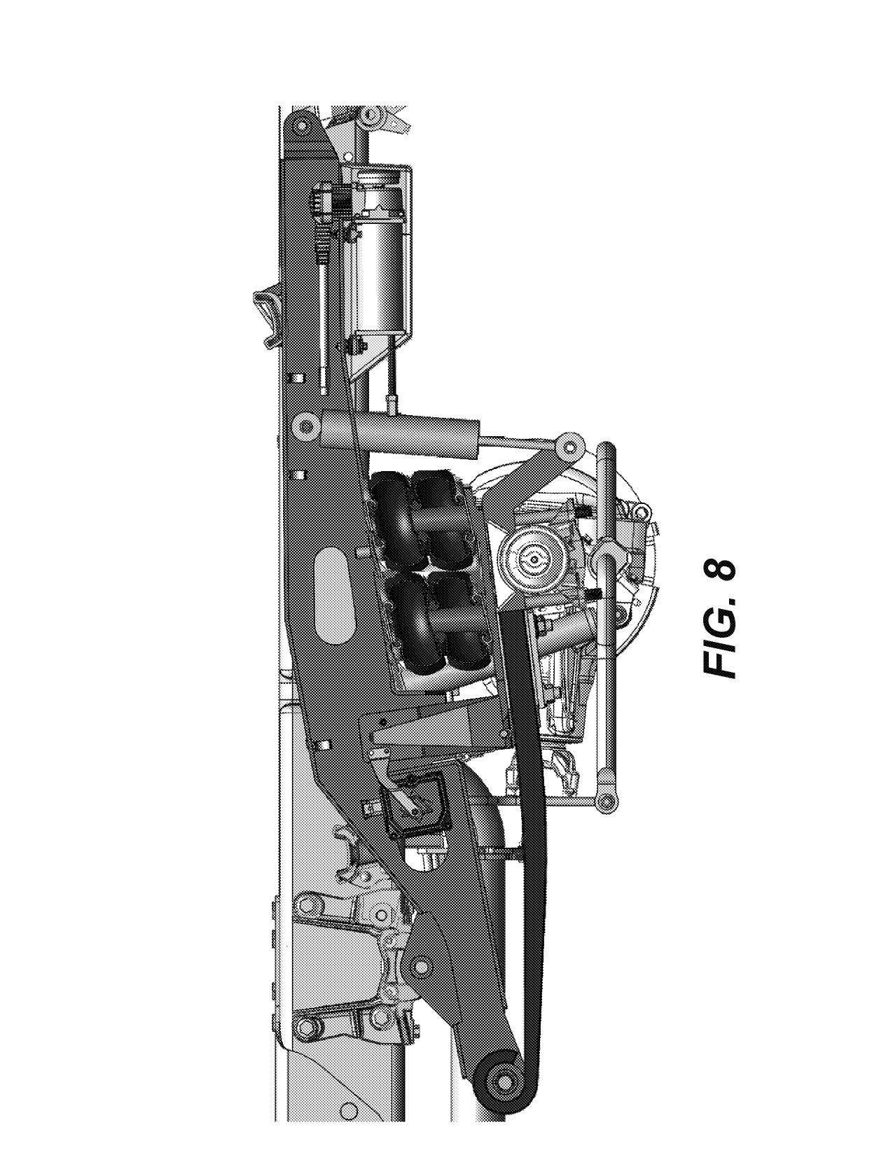

FIG. 8 depicts a side view of a suspension conversion assembly according to another embodiment of the present disclosure. The suspension conversion assembly shown on FIG. 8 may be similar or identical to the other suspension conversion assemblies shown and described, above, except for the differences described herein.

The suspension conversion assembly shown on FIG. 8 includes two separate air springs on each side of the vehicle, which can provide packing advantages over alternative designs with a single air spring per side. The two separate air springs may each have a smaller outside diameter (OD) that a single-air spring solution. The two air springs may be mounted in front of the axle centerline and behind the centerline, parallel with the spring beam, respectively. The compressor may mount directly into the brace, as shown on FIG. 8. A shroud, or enclosure of rubber or another resilient material, surrounds the compressor to protect the compressor from water splash, debris, dust, mud, etc.

In some cases, customers want to “lift” their trucks, adding 2”, 4”, or 6” spacers under the leaf springs to raise the ride height of the truck. The suspension conversion assembly shown on FIG. 8 allows customers to add these same lift blocks between the axle mount and top of the axle. The axle clamp bolts may be increased in length to accommodate addition of lift blocks.

The shock absorber may be required to provide relatively higher damping force than stock shock absorbers used with leaf springs. By eliminating leaf springs, associated spring inter-leaf damping is also reduced, so the new air spring suspension may require additional damping. The suspension conversion assembly of the present disclosure may include such a high-damping shock absorber to handle the air spring more free movement. This also enables the use of the same shock for any lift, making it easier for customers to choose to lift their LSR-equipped suspension.

According to an aspect of the present disclosure, a suspension conversion assembly includes: a brace, a spring beam, a spring member, and a lateral support arm. The brace is configured to attach to a forward leaf spring mount and a rear leaf spring mount on a frame of a vehicle. For example, the brace 602 may be connected to the forward leaf spring mount via the at mounting bolt 610. The spring beam is pivotably attached to the brace at a pivot. The spring beam is configured to attach to an axle at an end thereof opposite from the pivot. The spring member extends between the spring beam and the axle. The lateral support arm is fixed to the spring beam and is configured to engage with a lateral support receiver of the brace for limiting movement of the axle in a lateral direction.

In some embodiments, the spring member comprises a coil spring. In some embodiments, the spring member comprises a hydraulic spring. In some embodiments, the spring member includes an air spring.

In some embodiments, the suspension conversion assembly further includes an air compressor mounted on the brace and which fluidly coupled to the air spring to supply pressurized air thereto. For example, the compressor 526 may be mounted to the brace 502, 602 via a compressor adapter 524 to supply pressurized air to the air spring.

In some embodiments, the suspension conversion assembly further includes a pneumatic control module configured to regulate pressure in the air spring to maintain a target ride height. In some embodiments, the pneumatic control module is operatively coupled to a displacement sensor for monitoring a vertical displacement of the axle relative to the brace. In some embodiments, the suspension conversion assembly includes a flag 629 attached to the lateral support arm 620, and the displacement sensor includes an array of hall-effect sensors configured to detect a position of the flag 629. In some embodiments, the displacement sensor is integrated within the pneumatic control module. In some embodiments, a magnet is bolted or otherwise attached to the flag 629. The displacement sensor may detect a position of the magnet, thereby sensing the vertical displacement of the axle relative to the brace.

In some embodiments, the lateral support arm includes a vertical portion 628 and a horizontal portion 626, with bend therebetween. The vertical portion 628 may extend into the lateral support receiver 630 of the brace 602 for limiting movement of the axle in the lateral direction. The horizontal portion 626 of the lateral support arm 620 may define a lower spring mount for engaging a lower end of the air spring 606.

In some embodiments, the suspension conversion assembly further includes a limit strap 614 configured to restrict a rebound extension of the spring member. In some embodiments, the limit strap 614 is connected between the lateral support arm 620 and the lateral support receiver 630.

In some embodiments, the suspension conversion assembly further includes a shock absorber to an end of the spring beam opposite from the pivot. For example, the suspension conversion assembly 200 shown on FIG. 2 includes a shock absorber 204 connected to an end of the spring beam 214 opposite from the spring beam mounting hole 216 that functions as the pivot.

In some embodiments, the forward leaf spring mount is located between the pivot and the rear leaf spring mount. For example, the suspension conversion assembly 200 shown on FIG. 3 includes the front mounting tube 218, which facilitates secure attachment to the forward leaf spring mount 220, located aft of the spring beam mounting hole 216 that functions as the pivot. Thus, in at least the embodiment of FIG. 3, the forward leaf spring mount is located between the pivot and the rear leaf spring mount.

In some embodiments, the pivot is located between the forward leaf spring mount and the rear leaf spring mount. For example, the conversion assembly shown on FIGS. 5A-5C includes the forward leaf spring mount 514 located aft of the spring beam mounting hole 516 that functions as the pivot. Thus, in at least the embodiment of FIGS. 5A-5C, the forward leaf spring mount is located between the pivot and the rear leaf spring mount.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A suspension conversion assembly, comprising:
a brace configured to attach to a forward leaf spring mount and a rear leaf spring mount, each on a frame of a vehicle;
a spring beam pivotably attached to the brace at a pivot, wherein the spring beam is configured to attach to an axle at an end thereof opposite from the pivot;
a spring member extending between the spring beam and the axle; and
a lateral support arm fixed to the spring beam and configured to engage with a lateral support receiver of the brace for limiting movement of the axle in a lateral direction.

2. The suspension conversion assembly of claim 1, wherein the spring member includes a coil spring.

3. The suspension conversion assembly of claim 1, wherein the spring member includes a hydraulic spring.

4. The suspension conversion assembly of claim 1, wherein the spring member includes an air spring.

5. The suspension conversion assembly of claim 4, further comprising an air compressor mounted on the brace and fluidly coupled to the air spring to supply pressurized air thereto.

6. The suspension conversion assembly of claim 4, further comprising a pneumatic control module configured to regulate pressure in the air spring to maintain a target ride height.

7. The suspension conversion assembly of claim 6, wherein the pneumatic control module is operatively coupled to a displacement sensor for monitoring a vertical displacement of the axle relative to the brace.

8. The suspension conversion assembly of claim 7, further comprising a flag attached to the lateral support arm, and wherein the displacement sensor includes an array of hall-effect sensors configured to detect a position of the flag.

9. The suspension conversion assembly of claim 7, wherein the displacement sensor is integrated within the pneumatic control module.

10. The suspension conversion assembly of claim 4, wherein the lateral support arm includes a vertical portion and a horizontal portion with bend therebetween,
wherein the vertical portion extends into the lateral support receiver of the brace for limiting movement of the axle in the lateral direction, and
wherein the horizontal portion of the lateral support arm defines a lower spring mount for engaging a lower end of the air spring.

11. The suspension conversion assembly of claim 1, further comprising a limit strap configured to restrict a rebound extension of the spring member.

12. The suspension conversion assembly of claim 11, wherein the limit strap is connected between the lateral support arm and the lateral support receiver.

13. The suspension conversion assembly of claim 1, further comprising a shock absorber coupled to an end of the spring beam opposite from the pivot.

14. The suspension conversion assembly of claim 1, wherein the forward leaf spring mount is located between the pivot and the rear leaf spring mount.

15. A suspension conversion assembly, comprising:
a brace configured to attach to a forward leaf spring mount and a rear leaf spring mount, each on a frame of a vehicle;
a spring beam pivotably attached to the brace at a pivot, wherein the spring beam is configured to attach to an axle at a position thereof spaced apart from the pivot;
a spring member extending between the spring beam and the axle; and
an axle adapter that attaches the axle to the spring beam and the spring member.

16. The suspension conversion assembly of claim 15, wherein the spring member includes an air spring.

17. The suspension conversion assembly of claim 16, further comprising an air compressor mounted on the brace and fluidly coupled to the air spring to supply pressurized air thereto.

18. The suspension conversion assembly of claim 16, further comprising a pneumatic control module configured to regulate pressure in the air spring to maintain a target ride height.

19. The suspension conversion assembly of claim 18, wherein the pneumatic control module is operatively coupled to a displacement sensor for monitoring a vertical displacement of the axle relative to the brace.

20. The suspension conversion assembly of claim 15, wherein the forward leaf spring mount is located between the pivot and the rear leaf spring mount.
